(19) United States
(12) Patent Application Publication
(10) Pub. No.: US 2011/0210814 A1
(43) Pub. Date: Sep. 1, 2011

(54) MULTI-LAYER BLADE FUSE AND THE MANUFACTURING METHOD THEREOF

(75) Inventors: Xiurong Lu, Nanjing (CN); Shirong Nan, Nanjing (CN); Manxue Yang, Nanjing (CN)

(73) Assignee: NANJING SART SCIENCE & TECHNOLOGY DEVELOPMENT CO., LTD

(21) Appl. No.: 13/063,213

(22) PCT Filed: Nov. 20, 2009
(86) PCT No.: PCT/CN2009/001291

§ 371 Date: Mar. 10, 2011

(30) Foreign Application Priority Data
Nov. 25, 2008 (CN) 200810235440.X
Nov. 25, 2008 (CN) 200820217547.7

(51) Int. Cl. H01H 85/044; H01H 69/02

(52) U.S. Cl. 337/296; 29/623

(57) ABSTRACT

The invention relates to the field of fuses, and particularly a multi-layer blade fuse and its manufacturing method. The said multi-layer blade fuse comprises a ceramic substrate, back electrodes, front electrodes, fuse wire, protective layers and metal ends, wherein the fuse wire is prepared in multiple layers and the adjacent layers of fuse wire are connected in a head-to-tail style; the two lead-outs of the fuse wire as a whole are respectively connected to the two front electrodes located at the two ends of the substrate, and each layer of the fuse wire is deposited with a protective layer. During manufacturing, all protective layers but the upmost one leave the tail of each layer of fuse wire uncovered so that the head-to-tail series connection is possible. Compared with the prior methods, the method disclosed herein is characteristic of simpler manufacturing processes, less investment on equipments and much shorter manufacturing duration, which consequently reduce the cost.

### FIELD OF THE INVENTION

This invention relates to the field of fuses, and particularly to a blade fuse used to protect electronic components and its manufacturing method.

### BACKGROUND OF THE INVENTION

Most fuses are currently made by adopting chip-resistor manufacturing methods, and they have only one layer of printed fuse wire. Though the fuse wire so manufactured can be patterned in such various forms as straight, battlement-shaped or serpentine line, it is limited in total length and unable to be used on many occasions when high anti-surge capability is required. There exists another type of fuses. They have multiple layers of printed fuse wire and are able to be used on many occasions when high anti-surge capability is required. Specifically, these fuses have a monolithic structure that consists of three or more layers of glass ceramic, each layer having been deposited with a metal film. These monolithic-structure fuses are covered with a conductive layer at both ends, which are bridged by the metal films lying in parallel in between. These monolithic-structure fuses are manufactured as follows: a metal film is deposited on the green body of the substrate made of glass ceramic, and the wet tape-casting technology is thereafter adopted to form a very thin layer of glass ceramic thereupon; the same process is repeated so that a desired number of layers is obtained; after a monolithic green body being obtained thereby, it is subject to horizontal and vertical cutting so that the green bodies of independent fuses are formed; sintering the green bodies into ceramic and then encapsulating the two ends by electroplating.

When the monolithic-structure method abovementioned is adopted to manufacture the multi-layer fuse, it is characteristic of complicated processes, large investment on equipments and long manufacturing duration, which make it difficult to be utilized extensively.

### DESCRIPTION OF THE INVENTION

This invention is intended to provide a multi-layer blade fuse that is characteristic of simple manufacturing process, small investment on equipments and short manufacturing duration, and can be used on most occasions when high anti-surge capability is required.

A multi-layer blade fuse, comprising a ceramic substrate, back electrodes, front electrodes, a fuse wire, protective layers and metal ends; the fuse wire has multiple layers and the adjacent layers are connected in a head-to-tail style; the two lead-out ends of the fuse wire are connected to the two front electrodes located on the two ends of the substrate; each layer of the fuse wire is deposited with the protective layer.

It is recognized by those skilled in this field, the said metal ends include end inner electrodes and end electrodes (Ni).

A multi-layer blade fuse, wherein the back electrodes, the front electrodes and metal ends are printed with the conventional single-layer printing technology, and all layers of the fuse wire and all protective layers are printed with the conventional single-layer printing technology as well; the multi-layer printing technology embodied herein is reflected in the following processes: the lowest layer of the fuse wire (hereafter referred to as “the lower lead-out fuse wire”), the first protective layer, the middle layer of the fuse wire (hereafter referred to as “the middle fuse wire”), the middle protective layer, the upper layer of the fuse wire (hereafter referred to as “upper lead-out fuse wire”), and the third protective layer are printed on the ceramic substrate in succession; the head of the lower lead-out fuse wire is connected to one front electrode at one end of the substrate while its tail keeps unconnected to the other front electrode at the opposite end of the substrate; the first protective layer is printed on the lower lead-out fuse wire, it being shorter than the lower lead-out fuse wire so that the tail of the lower lead-out fuse wire projects out; the middle fuse wire is printed upon the first protective layer, not connecting to either of the two front electrodes, but its head connecting to the tail of the lower lead-out fuse link; the middle protective layer is printed upon the middle fuse wire, keeping the tail of the middle fuse wire projecting out; the upper lead-out fuse wire is printed upon the middle protective layer, its head connecting to the tail of the middle fuse wire while its tail connecting to the other front electrode at the opposite end of the substrate. In doing so, the three layers of the fuse wire connect to one another in a head-to-tail style, in other words, the three layers of the fuse wire are in series connection, which effectively elongates the total length of the fuse wire, and its anti-surge capability is consequently enhanced.

The said middle fuse wire and middle protective layer refers to the fuse wire and its corresponding protective layers between the first protective layer and the last layer of the fuse wire (upper lead-out fuse wire), they can be either one layer or an odd-number multiple, for example, 3 or 5 layers, however, as is recognized by those skilled in this field, each layer of the middle fuse wire should be printed with a protective layer.

The said third protective layer refers to the protective layer printed upon the upper lead-out layer, a.k.a the upmost protective layer of the whole fuse; the number “third” does not necessarily mean “the third” ordinally, it depends upon the specific layers contained in the middle protective layer. It may mean either exactly the ordinal “third”, as is shown in the embodiment herein, or the fifth layer provided that the middle protective layers contain three layers in total; in this way, the exact meaning of the said third protective layer can be analogically deduced.

In this invention, all components of the fuse can be made of conventional materials.

Compared with prior methods, the method disclosed in this invention is characteristic of simpler manufacturing processes, less investment on equipments and much shorter manufacturing duration, which consequently reduce the cost.

### BRIEF DESCRIPTION OF THE DRAWINGS

FIG. 1 a flowing diagram showing the manufacturing method disclosed in this invention;

FIG. 2 the substrate;

FIG. 3 forming back electrodes

FIG. 4 forming front electrodes

FIG. 5 forming the lower lead-out fuse wire

FIG. 6 a plan view of FIG. 5

FIG. 7 forming the first protective layer

FIG. 8 a plan view of FIG. 7

FIG. 9 forming the middle fuse wire

FIG. 10 a plan view of FIG. 9

FIG. 11 forming the middle protective layer

FIG. 12 a plan view of FIG. 11

FIG. 13 forming the upper lead-out fuse wire

FIG. 14 a plan view of FIG. 13

FIG. 15 forming the third protective layer

FIG. 16 forming the end inner electrodes

FIG. 17 forming the end electrodes

FIG. 18 a structure diagram of the blade fuse disclose in this new utility model, wherein: 1. the substrate; 2. back electrodes; 3. front electrodes; 4. the lower lead-out fuse wire; 5. the first protective layer; 6. the middle fuse wire; 7. the second protective layer; 8. the upper lead-out fuse wire; 9. the third protective layer; 10. inner electrodes; 11. end electrodes (Ni); 12. end electrodes (Sn).

### DETAILED DESCRIPTION OF THE PREFERRED EMBODIMENTS

The terms used in this invention, except as specifically explained, are generally recognized by those skilled in this field.

Preferred embodiments are provided in the following to facilitate a detailed description of this invention. Thus, although specific embodiments are described herein, it will be recognized that the scope of this invention is not restricted to the said description.

In the following embodiments, the steps and technologies that are not elaborated, for example, screen-printing technology, are conventional to those skilled in this field.

### Embodiment 1 the Manufacture of Three-Layer Blade Fuse

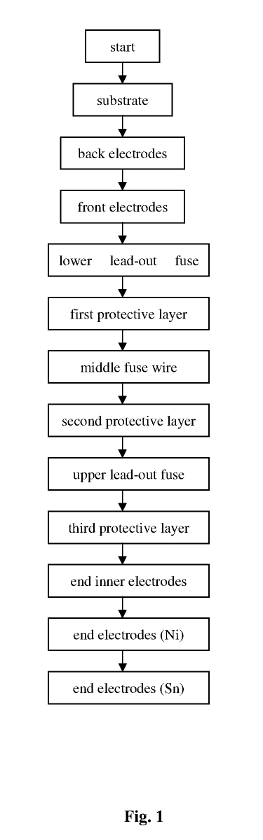

As is shown in FIG. 1, the manufacturing steps include:

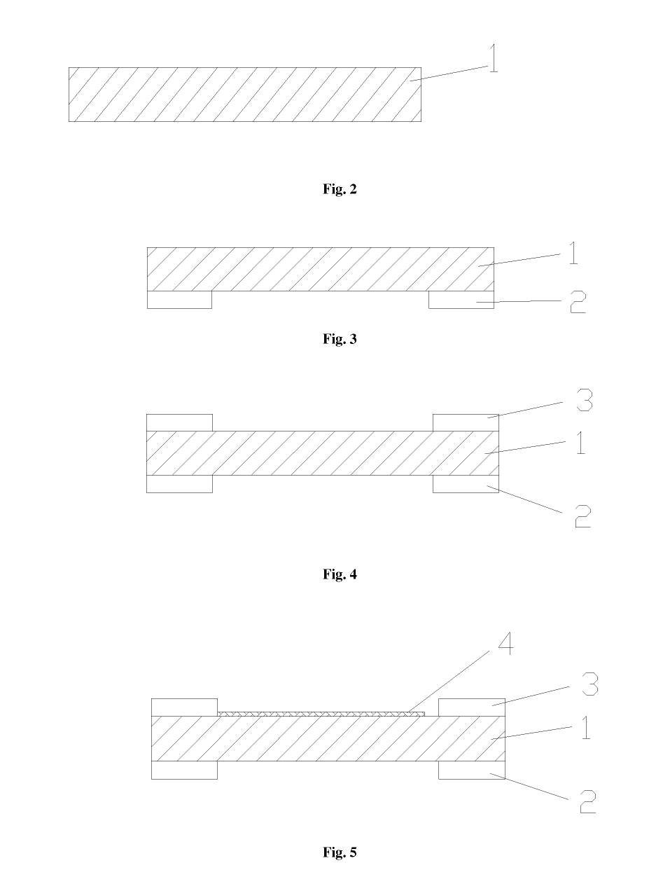

I. providing the substrate 1, which is made of alumina or steatite, as is shown in FIG. 2;
II. forming the back electrodes

As is shown in FIG. 3, a conductive paste, which contains silver, is screen-printed on both ends of the back side of the substrate 1 to form the pattern of the back electrodes 2;

III. drying the substrate in a drying oven (temperature: 150□ time:15 min);
IV. forming the front electrodes

As is shown in FIG. 4, the front electrodes 3 are screen-printed on the front side of the substrate 1, the conductive paste contains silver or silver-palladium alloy;

V. drying the substrate in a drying oven (temperature 150□ time: 15 min);
VI. sintering the substrate in a sintering oven (maximal temperature: 600□-850□ time:60 min);
VII. patterning the lower lead-out fuse wire

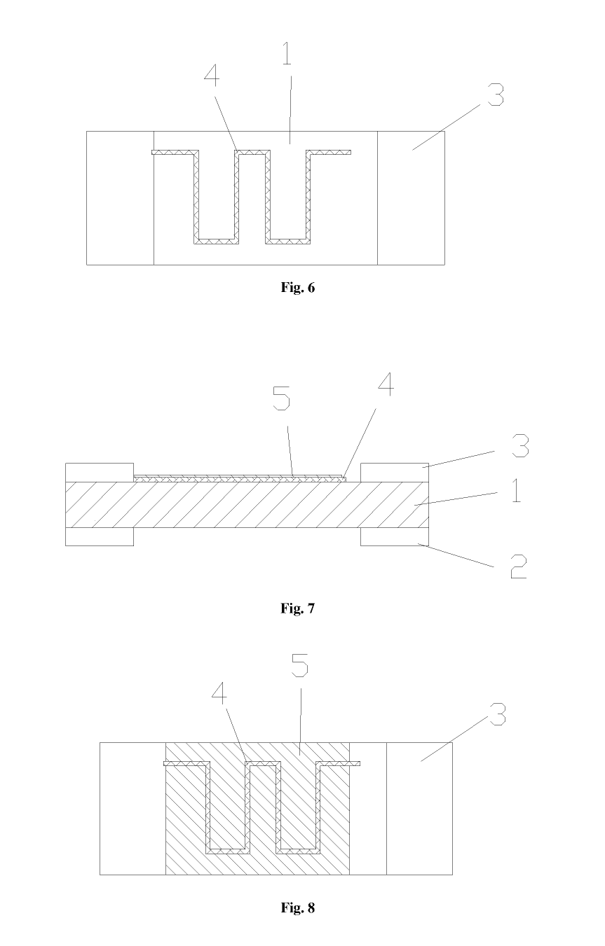

As is shown in FIG. 5 and FIG. 6, the lower lead-out fuse wire 4, located between the two front electrodes, is screen-printed on the ceramic substrate, its head connecting to one front electrode while its tail keeping a certain distance (therefore, unconnected) to the other front electrode; the pattern of the lower lead-out fuse wire can be designed in such various forms as straight, battlement-shaped or serpentine line (battlement-shape wire is adopted in this preferred embodiment); the main components of the conductive paste are some metals, such as silver, palladium, copper and platinum, or their mixture;

VIII. drying the substrate in a drying oven (temperature: 1500 time: 15 min);
IX. sintering the substrate in a sintering oven (maximal temperature: 600□-850□ time:60 min);
X. forming the first protective layer

As is shown in FIG. 7 and FIG. 8, the first protective layer 5 (made of ethoxyline resin or phenolic resin) is screen-printed on the lower lead-out fuse wire 4, keeping the first protective layer 5 shorter than the lower lead-out fuse wire 4 so that the tail of the lower lead-out fuse wire 4 projects out;

XI. patterning the middle fuse wire

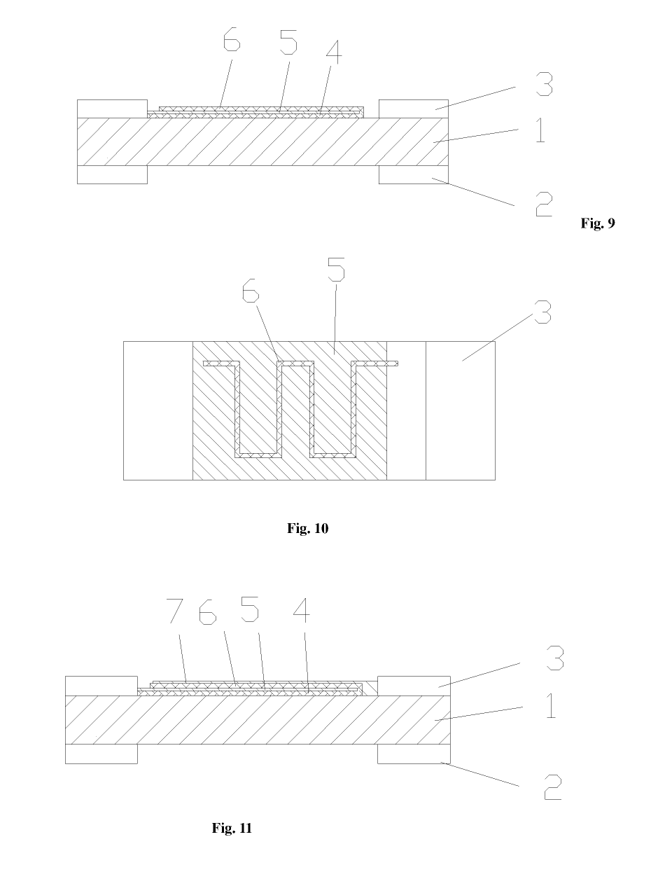

As is shown in FIG. 9 and FIG. 10, the pattern of the middle fuse wire 6 is screen-printed on the first protective layer 5, its head connecting to the tail of the lower lead-out fuse wire that projects out of the first protective layer; the pattern of the middle fuse wire 6 is located at the central place of the substrate, keeping unconnected to neither of the front electrodes 3;

XII. drying the substrate in a drying oven (temperature: 150□ time:15 min);
XIII. sintering the substrate in a sintering oven (maximal temperature: 6000-850□ time:60 min);
XIV. forming the middle protective layer (a.k.a the second protective layer in this preferred embodiment)

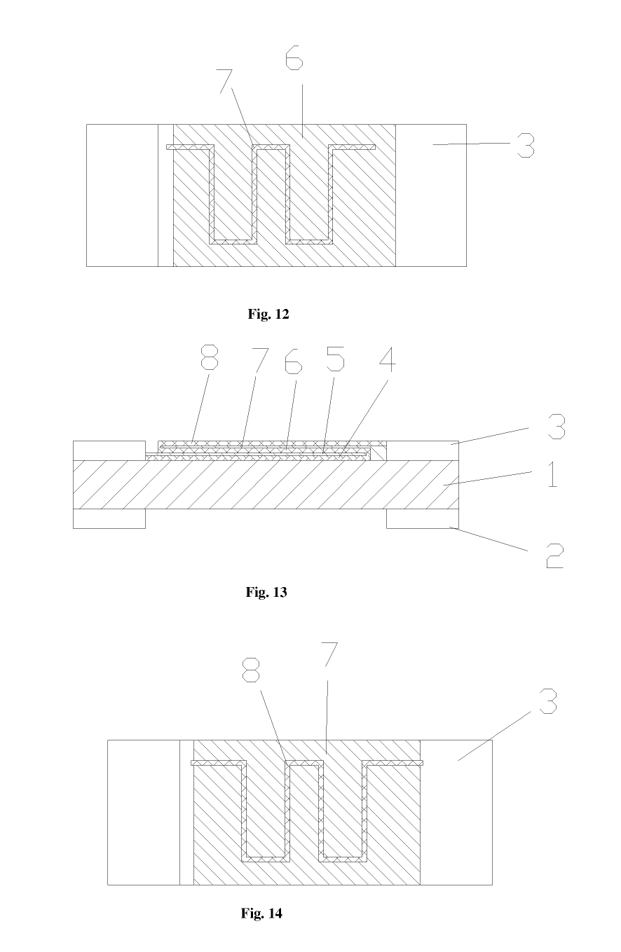

As is shown in FIG. 11 and FIG. 12, the second protective layer 7 (made of the same material as the first protective layer) is screen-printed on the pattern of the middle fuse wire 6, keeping the tail of the middle fuse wire 6 uncovered;

XV. patterning the upper lead-out fuse wire

As is shown in FIG. 13 and FIG. 14, the pattern of the upper lead-out fuse wire 8 is screen-printed on the second protective layer 7, its head connecting to the tail of the middle fuse wire 6 that projects out of the second protective layer 7 while its tail connecting to the other front electrode 3 at the opposite end of the substrate (one of the two front electrodes 3 has already been connected to the head of the lower lead-out fuse wire);

XVI. drying the substrate in a drying oven (temperature: 1500 time: 15 min);
XVII. sintering the substrate in a sintering oven (maximal temperature: 600□-8500 time:60 min);
XVIII. forming the third protective layer

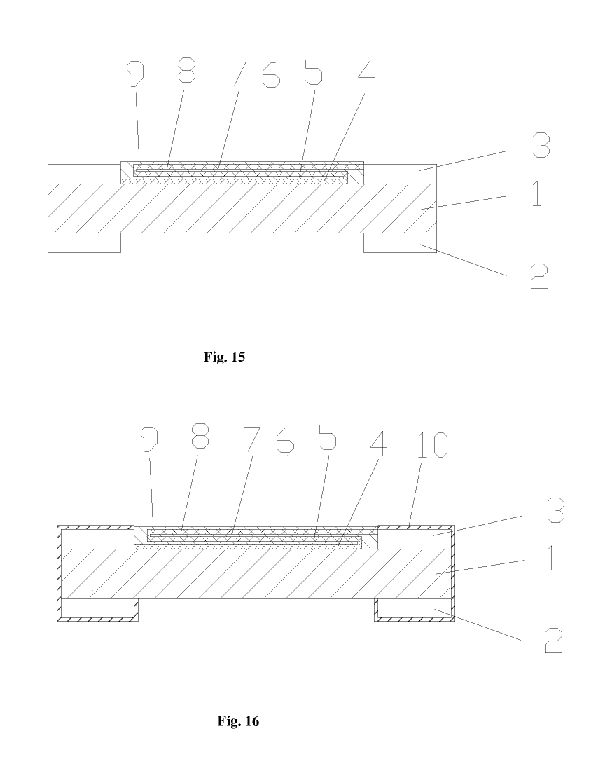

As is shown in FIG. 15, the third protective layer 9 made of the same material as the first and second protective layer is screen-printed on the upper lead-out fuse wire 8, covering all the front side of the substrate 1 except the two front electrodes;

XIX. forming the end inner electrodes

As is shown in FIG. 16, the end inner electrodes 10 made of silver are dip encapsulated on the substrate 1;

XX. forming the end electrodes

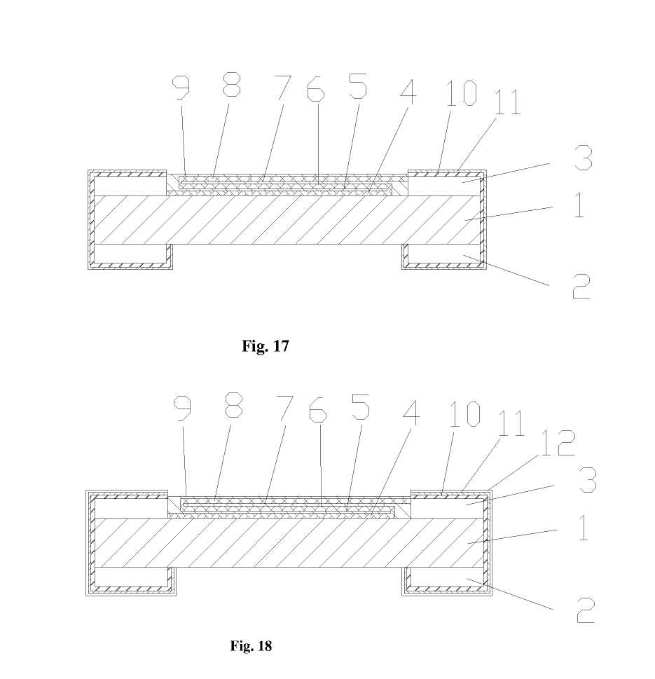

As is shown in FIG. 17 and FIG. 18, the end electrodes 11 and 12 made of nickel and tin respectively are barrel-plated on the substrate 1, covering the back electrodes, front electrodes and end inner electrodes; the three-layer blade fuse is therefore obtained, shown in FIG. 18.

Amongst the steps described above, step X, XIV and XVIII are accompanied with the same drying and sintering processes as mentioned above. Since these processes are recognized to those skilled in this field, no detailed description is provided herein.

The said middle fuse wire and middle protective layer described herein contain only one layer respectively, however, as mentioned above, two or two times layers of fuse wire and protective layers can be added in between. In accordance with the head-to-tail technology disclosed in this preferred embodiment, those skilled in this field are able to manufacture a fuse containing multi-layered middle fuse wire and multi-layered middle protective layer.

### Embodiment 2

The products [S 1206-S-0.5A] manufactured through Embodiment 1 are tested in accordance with testing items and technical requirements stipulated in Chinese national standards GB9364.4-2006 and GB9364.1-1997. The results show that these products completely satisfy the stipulated specifications, particularly, compared with the conventional single-layer blade fuse, these products present significant improvement insofar as the anti-surge capability (surge caused by 10 times of rated current) is concerned. The test results of the fuses manufactured with the two different technologies are compared as follows:

TABLE 1
comparison of anti-aging capability

| | Fuses made with | | | |
|---|---|---|---|---|
| | conventional single-layer | | fuses made with | |
| | technology | | multi-layer technology | |
| | 2In breaking | | disclose herein | |
| | time | 10In breaking | 2In breaking | 10In breaking |
| No. | (mS) | time (μS) | time (mS) | time (μS) |
| 1 | 18.45 | 220 | 20.43 | 1280 |
| 2 | 16.17 | 190 | 32.32 | 1020 |
| 3 | 14.35 | 390 | 24.33 | 930 |
| 4 | 32.32 | 380 | 25.23 | 980 |
| 5 | 14.65 | 180 | 21.25 | 900 |
| 6 | 18.90 | 170 | 26.88 | 1120 |
| 7 | 20.78 | 280 | 31.67 | 1000 |
| 8 | 20.66 | 300 | 23.26 | 990 |
| 9 | 17.56 | 200 | 22.54 | 930 |
| 10 | 23.55 | 140 | 23.77 | 820 |

| | |
|---|---|
| conclusion | According to data shown above, the two types of fuses |
| | show no big difference when 2 times rated current is applied; |
| | but when 10 times rated current is applied, the breaking time |
| | of the fuses made with technology disclosed herein is much |
| | longer than that of the conventional single-layer fuses; a.k.a. |
| | they present better anti-surge capability. |

Note:
the test is conducted as follow: choosing 20 fuses from each group and applying with the rated current for 200 hours (temperature 25° C., humidity 40%), thereafter testing the breaking time of these fuses with 2 times and 10 times rated current respectively. Instruments used for this test are BXC-35A fusing testing device and DS5062M digital oscilloscope

1-5. (canceled)

6. A multi-layer blade fuse, comprising:
a ceramic substrate, a plurality of back electrodes, a plurality of front electrodes, a fuse wire, a plurality of protective layers and a plurality of metal ends, wherein the fuse wire is prepared in multiple layers and the adjacent layers are connected in a head-to-tail style on at least two lead-outs of the fuse wire respectively connected to the front electrodes located in the two ends of the substrate, wherein each layer of the fuse wire is covered with a protective layer.

7. The multi-layer blade fuse as defined in claim 6, wherein the layers of the said fuse wire is at least one of 3 and any odd number greater than 3.

8. A method for manufacturing the multi-layer blade fuse as defined in claim 6, comprising such steps as:
forming the back electrodes on the two ends of a back side of the ceramic substrate and the front electrodes on the two ends of a front side of the ceramic substrate;
forming the fuse wire and the protective layers; and
forming metal ends;
wherein the steps of forming the fuse wire and the protective layers include:
printing on the ceramic substrate a lower lead-out fuse wire, a first protective layer, a middle fuse wire, a middle protective layer, a upper lead-out fuse wire and a third protective layer in succession; a head of the lower lead-out fuse wire connects to one of the plurality of front electrodes while a tail of which keeps unconnected to the other of the front electrodes; the first protective layer printed on the lower lead-out fuse wire is shorter than the latter, which makes the tail of the lower lead-out fuse wire project out; the middle fuse wire is printed on the first protective layer, not connecting to either of the plurality of front electrodes but its head connecting to the tail of the lower lead-out fuse wire; the middle protective layer is printed on the middle fuse wire, keeping the tail of the middle fuse wire uncovered; the upper lead-out fuse wire is thereafter printed on the middle (second) protective layer, the head connecting to the tail of the middle fuse wire while the tail connecting to the other of the plurality of two front electrodes.

9. The method as defined in claim 8, wherein the middle fuse wire and the middle protective layer contains only one layer respectively.

10. The method as defined in claim 8, wherein the middle fuse wire and the middle protective layer contain multiple layers, the head of the first layer of the middle fuse wire connects to the tail of the lower lead-out fuse wire, and the protective layer is printed thereupon, keeping the tail of each layer of the middle fuse uncovered so that it can connect to the head of the next layer of fuse wire, repeating the same process till the desired number of the middle fuse wire is obtained, and then connecting the tail of the last layer of the middle fuse wire to the head of the upper lead-out fuse wire.
